(19) United States
(12) Patent Application Publication
(10) Pub. No.: US 2022/0027046 A1
(43) Pub. Date: Jan. 27, 2022

(54) DATA INPUT DEVICE, AND DATA INPUT METHOD THAT ARE CONFIGURED TO SWITCH DISPLAY OF CHARACTER INPUT BUTTONS IN RESPONSE TO INPUT OPERATIONS IN TWO DIRECTIONS

(71) Applicant: Rei Sato, Sakura-shi (JP)

(72) Inventor: Rei Sato, Sakura-shi (JP)

(21) Appl. No.: 16/934,976

(22) Filed: Jul. 21, 2020

(51) Int. Cl. G06F 3/0488; G06F 3/0482; G06F 3/0484

(52) U.S. Cl. CPC G06F 3/04886; G06F 3/0482; G06F 2203/04803; G06F 2203/04808; G06F 3/04845

(57) ABSTRACT

The present invention provides a novel character input system. The data input device 10 includes a display unit 11, a first detection unit 12, an input unit 13, and a second detection unit 14. The display unit 11 displays input buttons 1511 arranged in a plurality of rows and columns in a button display section 151. The first detection unit 12 detects a selection from the input buttons 1511 by the user. The input unit 13 performs data input according to the selected input button 1511. The second detection unit 14 detects an input operation in a first direction to the detection section 153 by the user and an input operation in a second direction that is different from the first direction to the detection section 153 by the user. The display unit 11 performs switching to a different one of partial arrays in the same array group by switching the display of the input buttons 1511 in the button display section 151 in response to an input operation in the first direction. The display unit 11 performs switching to one of array groups in a different category or to a different one of the array groups in the same category, by switching the display of the input buttons 1511 in the button display section 151 in response to an input operation in the second direction.

### BACKGROUND OF THE INVENTION

### 1. Field of the Invention

The present invention relates to a data input device, and data input method that are configured to switch the display of character input buttons in response to input operations in two directions.

### 2. Description of Related Art

In a mobile device provided with a touch panel, known character input methods include performing, with respect to an on-screen keyboard displayed on a screen, touch operations such as tapping (lightly tapping the touch panel), swiping (moving a finger up and down or from side to side while touching the touch panel), and flicking (flicking the screen on the touch panel). As such character input methods, inputting characters by way of flick input operations or multi-tap operations is known, for example (EP-2207083 A1). The above-described character input methods enable, for example, input of an alphabet without displaying all the letters of the alphabet at the same time on a screen, for example.

### SUMMARY OF THE INVENTION

With the foregoing in mind, it is an object of the present invention to provide a novel character input system.

In order to achieve the above object, the present invention provides a data input device including: a display unit; a first detection unit; an input unit; and a second detection unit. The display unit is configured to display input buttons in a plurality of rows and columns in a button display section. The first detection unit is configured to detect a selection from the input buttons by a user. The input unit is configured to perform data input according to the selected input button. The second detection unit is configured to detect an input operation in a first direction and an input operation in a second direction that is different from the first direction to a detection section by the user. The display unit displays, as the input buttons, partial arrays included in an array group in at least one category selected from the following categories (i-1) to (iv):

(i-1) an array group that includes partial arrays obtained by dividing a character input array for input of kana (the Japanese syllabary) through a multi-tap operation based on an order of display in response to input operations to respective ten number keys;
(i-2) an array group that includes partial arrays obtained by dividing a character input array for input of an alphabet through a multi-tap operation based on an order of display in response to input operations to respective ten number keys;
(i-3) an array group that includes partial arrays obtained by dividing a character input array for input of symbols through a multi-tap operation based on an order of display in response to an input operation to the respective ten number keys;
(ii) an array group that includes partial arrays obtained by dividing a key array of a keyboard into two to four segments;
(iii) an array group that includes partial arrays obtained by dividing the arrangement of kana in the Japanese syllabary table into two to four segments; and
(iv) an array group that includes partial arrays obtained by dividing arrangement of alphabet letters in alphabetical order into two to four segments.
The display unit performs first switching by switching a display of the input buttons in the button display section in response to the input operation in the first direction, and performs second switching by switching a display of the input buttons in the button display section in response to the input operation in the second direction. The first switching is switching to a different one of the partial arrays in the same array group, and the second switching is switching to one of the array groups in the other categories or to a different one of the array groups in the same category.

The present invention also provides a data input method including: a display step; a first detection step; an input step; and a second detection step. The display step is a step of displaying input buttons in a plurality of rows and columns in a button display section. The first detection step is a step of detecting a selection from the input buttons by a user. The input step is a step of performing data input according to the selected input button. The second detection step is a step of detecting an input operation in a first direction and an input operation in a second direction that is different from the first direction to a detection section by the user. In the display step, as the input buttons, partial arrays included in an array group in at least one category selected from the following categories (i-1) to (iv) are displayed:

(i-1) an array group that includes partial arrays obtained by dividing a character input array for input of kana through a multi-tap operation based on an order of display in response to input operations to respective ten number keys;
(i-2) an array group that includes partial arrays obtained by dividing a character input array for input of an alphabet through a multi-tap operation based on an order of display in response to input operations to respective ten number keys;
(i-3) an array group that includes partial arrays obtained by dividing a character input array for input of symbols through a multi-tap operation based on an order of display in response to an input operation to the respective ten number keys;
(ii) an array group that includes partial arrays obtained by dividing a key array of a keyboard into two to four segments;
(iii) an array group that includes partial arrays obtained by dividing the arrangement of kana in the Japanese syllabary table into two to four segments; and
(iv) an array group that includes partial arrays obtained by dividing arrangement of alphabet letters in alphabetical order into two to four segments.
The display unit performs first switching by switching a display of the input buttons in the button display section in response to the input operation in the first direction, and performs second switching by switching a display of the input buttons in the button display section in response to the input operation in the second direction. The first switching is switching to a different one of the partial arrays in the same array group. The second switching is switching to one of the array groups in the other categories or to a different one of the array groups in the same category, and the respective steps are executed by a computer.

The present invention also provides a computer-readable recording medium having recorded thereon a program for causing a computer to execute the respective steps in the method of the present invention.

The present invention can provide a novel character input system.

### BRIEF DESCRIPTION OF THE DRAWINGS

FIG. 1 shows an example of a data input device in a first embodiment of the present invention.

FIG. 2 is a block diagram showing an example of a system in the first embodiment of the present invention.

FIG. 3 is a schematic view showing an example where input buttons are displayed on a touch panel of a mobile device in the first embodiment of the present invention.

FIGS. 4A, 4B, and 4C are schematic views showing examples of the display mode of the input buttons in the first embodiment of the present invention.

FIG. 5 is a table showing an example of a character input array for input through a multi-tap operation.

FIG. 6 is a schematic view showing an example of input buttons displayed in a button display section in the first embodiment of the present invention.

FIG. 7 is a schematic view showing another example of the input buttons displayed in the button display section in the first embodiment of the present invention.

FIG. 8 is a table showing another example of the character input array for input through a multi-tap operation.

FIGS. 9A and 9B are a schematic view and a table showing still another example of the character input array for input through a multi-tap operation.

FIG. 10 is a schematic view showing still another example of the input buttons displayed in the button display section in the first embodiment of the present invention.

FIG. 11 is a schematic view showing still another example of the input buttons displayed in the button display section in the first embodiment of the present invention.

FIG. 12 is a schematic view showing still another example of the input buttons displayed in the button display section in the first embodiment of the present invention.

FIGS. 13A and 13B are schematic views showing an example of a symbol and number key array of a keyboard in the first embodiment of the present invention.

FIG. 14 is a schematic view showing still another example of the input buttons displayed in the button display section in the first embodiment of the present invention.

FIG. 15 is a schematic view showing still another example of the input buttons displayed in the button display section in the first embodiment of the present invention.

FIG. 16 is a schematic view showing still another example of the input buttons displayed in the button display section in the first embodiment of the present invention.

FIG. 17 is a schematic view showing still another example of input buttons displayed on a button display unit according to the first embodiment of the present invention.

FIGS. 18A and 18B are tables showing examples of rows and columns that respectively indicate the display order resulting from first switching and the display order resulting from second switching in the first embodiment of the present invention.

FIG. 19 is a schematic view showing another example where the input buttons are displayed on the touch panel of the mobile device in the first embodiment of the present invention.

FIG. 20 is a flowchart illustrating an example of a data input method in the first embodiment of the present invention.

FIGS. 21A and 21B are schematic views showing an example where input buttons are displayed on a touch panel of a smartwatch in a second embodiment of the present invention.

FIG. 22 is a block diagram showing an example of a system in a third embodiment of the present invention.

FIG. 23 is a schematic view showing still another example where the input buttons are displayed on the touch panel of the mobile device in the first embodiment of the present invention.

### DETAILED DESCRIPTION OF THE INVENTION

Embodiments of the present invention will be described with reference to the drawings. The present invention is by no means limited or restricted by the following embodiments. In the drawings to be described below, the same components and portions are given the same reference numerals. Unless otherwise stated, the description in each of the embodiments also is applicable to the other embodiments. Further, unless otherwise stated, the configurations of the respective embodiments can be used in any desired combination.

### First Embodiment

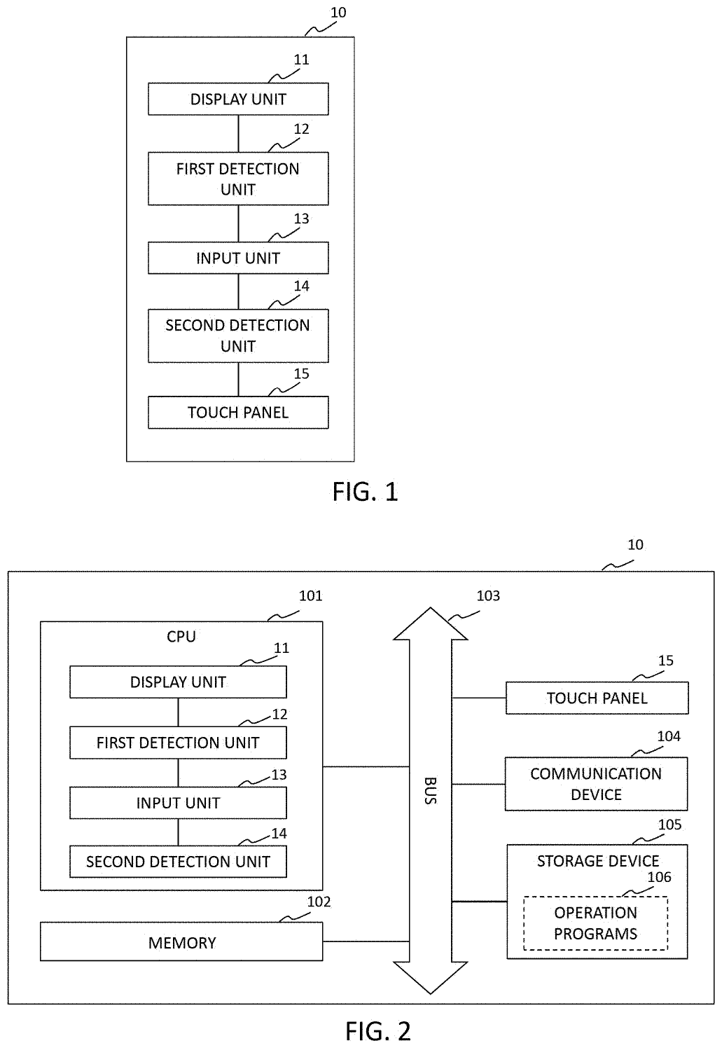

In the first embodiment, data input is performed using a touch panel of a mobile device. FIG. 1 is a block diagram showing an example of the configuration of a data input device 10 according to the present embodiment. The data input device 10 includes a display unit 11, a first detection unit 12, an input unit 13, a second detection unit 14, and a touch panel 15.

For example, the data input device 10 may be a single device that includes the above-described respective components, or may be a device (system) constituted by the respective components adapted to be connectable to each other via a wired or wireless communication line network. The communication line network is not particularly limited, and a known network can be used. The communication line network may be either wired or wireless, for example. The communication line network may be, for example, an Internet connection, the World Wide Web (WWW), a telephone line, a local area network (LAN), or Wireless Fidelity (WiFi). The data input device 10 may be built in a server as a system constituting the server, for example. The data input device 10 may be, for example, a computer with the program of the present invention installed therein.

In the present embodiment, the data input device 10 is a mobile device provided with a touch panel. The touch panel is not particularly limited, and may be, for example, a display device having two functions, namely, a display function and an input function. The mobile device is not particularly limited, and may be, for example, a smartphone, a tablet terminal, or a smartwatch. The data input device 10 need only include the display unit 11, the first detection unit 12, the input unit 13, and the second detection unit 14. As described below, the data input device 10 need not include a touch panel, and is not limited to a mobile device.

FIG. 2 is a block diagram showing an example of a hardware configuration of the data input device 10. The data input device 10 includes, for example, a central processing unit (CPU) 101, a memory 102, a touch panel 15, a bus 103, a communication device 104, and a storage device 105. The components of the data input device 10 are connected to each other with their interfaces (I/F) being connected via the bus 103, for example.

The CPU 101 controls the entire data input device 10. In the data input device 10, the CPU 101 executes the program of the present invention and other programs, and also performs reading and writing of various information. Specifically, in the data input device 10, the CPU 101 serves as the display unit 11, the first detection unit 12, the input unit 13, and the second detection unit 14, for example.

The bus 103 connects the respective functional units such as the CPU 101 and the memory 102, for example. The bus 103 also can be connected to external devices, for example. Examples of the external devices include a screen including a button display section and a reception device including a detection section, which will be described below. The data input device 10 can be connected to a communication line network using the communication device 104 connected to the bus 103, and also can be connected to the external devices via the communication line network.

The memory 102 includes a main memory, for example, and the main memory is also referred to as a “main storage device”. When the CPU 101 executes processing, for example, the memory 102 reads various operation programs 106, including the program of the present invention, stored in an auxiliary storage device to be described below, and the CPU 101 executes the programs 106 upon receipt of the data from the memory 102. The main memory is, for example, a random-access memory (RAM). The memory 102 further includes a read read-only memory (ROM), for example.

The storage device 105 is also referred to as a so-called “auxiliary storage device” in contrast to the main memory (main storage device), for example. The storage device 105 includes, for example, a storage medium and a drive for reading/writing data from/on the storage medium. The storage medium is not particularly limited, and may be a storage medium of a built-in type or an external type, for example. Examples of the storage medium include a hard disk (HD), CD-ROM, CD-R, CD-RW, MO, DVD, a flash memory, and a memory card. The drive is not particularly limited. Also, the storage device 105 may be, for example, a hard disk drive (HDD), which is a drive integrated with a storage medium. As described above, the storage device 105 stores the operation programs 106, for example. The storage device 105 also may store, for example, information on partial arrays, information on the display order, and the like, which will be described below.

In the data input device 10, the memory 102 and the storage device 105 also can store user access information, user log information, and information acquired from an external database (not shown).

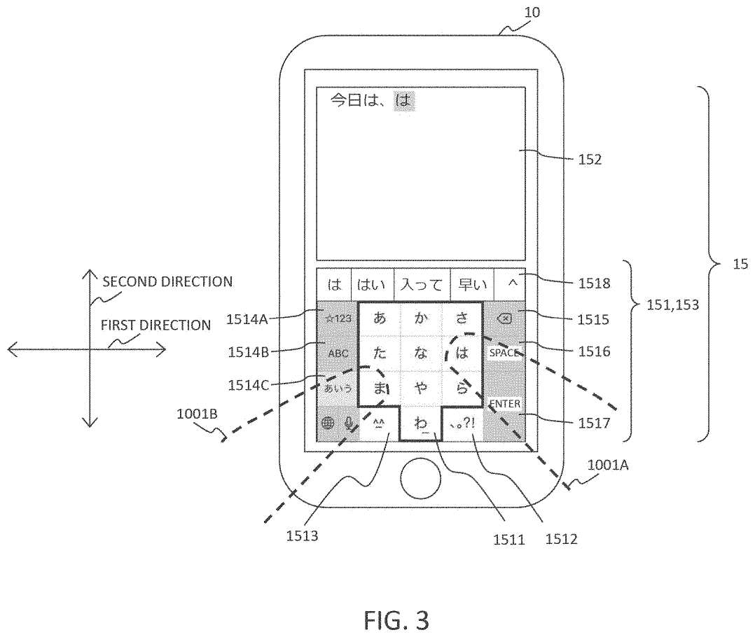

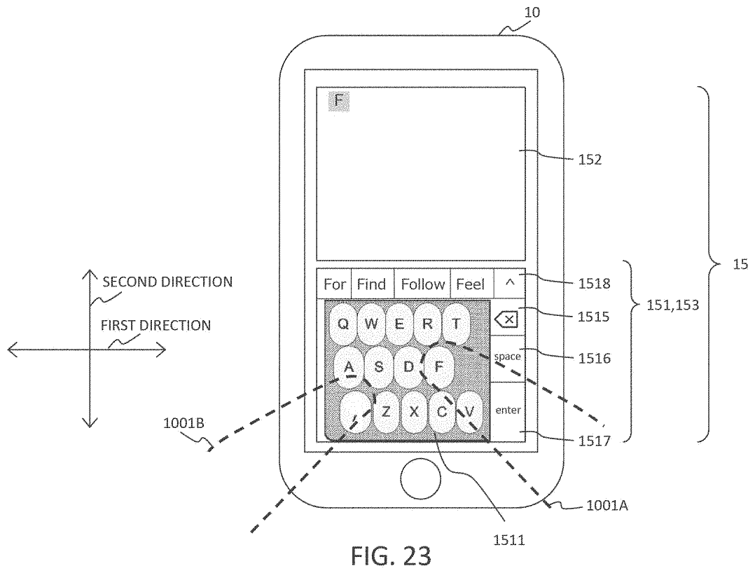

The display unit 11 displays input buttons 1511 arranged in a plurality of rows and columns in a button display section 151. FIG. 3 shows an example where, in the data input device 10, which is a mobile device, the input buttons 1511 are displayed in the button display section 151 of the touch panel 15. In the example shown in FIG. 3, the input buttons 1511 display a partial array indicating the first row of hiragana. On the other hand, in the example shown in FIG. 23, the input buttons 1511 display a partial array indicating a left segment of the QWERTY layout.

As shown in FIG. 3, the input buttons 1511 are displayed in the button display section 151. Then, as described below, the display unit 11 switches the display of the input buttons 1511. The button display section 151 need only display the input buttons 1511, and may or may not display buttons other than the input buttons 1511. The buttons other than the input buttons 1511 are not particularly limited, and can be set as appropriate according to the number of buttons that the button display section 151 can display, the type of array group to be described below, etc. In FIG. 3, as the buttons other than the input buttons 1511, a symbol button 1512, an emoticon/lower-case button 1513, number, alphabet, and kana switching buttons 1514A to 1514C, a character delete button 1515, a space/conversion button 1516, a linefeed/enter button 1517, a keyboard input switching button, and a voice input button are displayed in the button display section 151. The emoticon/lower-case button 1513, the space/conversion button 1516, and the linefeed/enter button 1517 are each configured to display either one of the options indicated before and after “/” depending on, for example, whether there is a temporary selected character to be described below. A candidate display section 1518 is also displayed, in which input candidates are displayed according to information on the selected character.

In the example shown in FIG. 23, the input buttons 1511 are composed of the rows of “qwert”, “asdf”, and “zxcvb”, and thus are arranged in three rows and five columns. As described above, in the present invention, “a plurality of rows and columns” is not limited as long as there are two or more rows and columns, and the arrangement of the rows and columns is not limited to a rectangular form. Further, either the rows or columns do not have to be arranged linearly. The number of the “plurality of rows and columns” can be set as appropriate according to, for example, the type of array to be displayed. The number of the “plurality of rows and columns” may change before and after display switching to be described below, for example. In this case, a region where the input buttons 1511 are provided (a portion surrounded by the thick line in FIG. 23) may or may not change.

With the configuration in which the input buttons 1511 are displayed in a plurality of rows and columns, for example, as compared with the case where characters of the input buttons 1511 are displayed in a single row or a single column, the number of times, amount, time period, and the like required for operations for displaying a character that the user wants to input can be reduced, whereby the user's burden can be reduced. Specifically, for example, in order to display the QWERTY layout in such a manner that the rows of “qwert”, “asdf”, “zxcvb”, “yuiop”, “ghjkl”, and “nm,” are display in a one-at-a-time manner, operations for displaying these six rows (regarded as “six operations”) are required. In contrast, for example, in the case of display switching of partial arrays obtained by dividing a key array of a keyboard into two segments (corresponding to the category (ii)) as described below, only two operations are required. Accordingly, for example, the first to last partial arrays in the display order, which will be described below, can be displayed through single swiping or the like in the region of the detection section 153. Moreover, the configuration in which the input buttons 1511 are displayed in a plurality of rows and columns improves the perspicuity of characters. Accordingly, for example, the user can find a desired character among a plurality of characters in a shorter period of time, whereby the user's burden can be reduced.

The rows and columns of the input buttons 1511 can be set as appropriate according to, for example, the type of characters assigned to the input buttons 1511. The number of rows and the number of columns each may be, for example, 2 to 7, 2 to 6, 3 to 5, or 3 or 4. By setting the upper limit of each of the number of rows and the number of columns to, for example, 7, 6, 5, or 4, the user can find a desired character among a plurality of characters in a shorter period of time, and also, the time period, the number of times, and the like required for operations for selecting the desired character can be reduced, whereby the user's burden can be reduced.

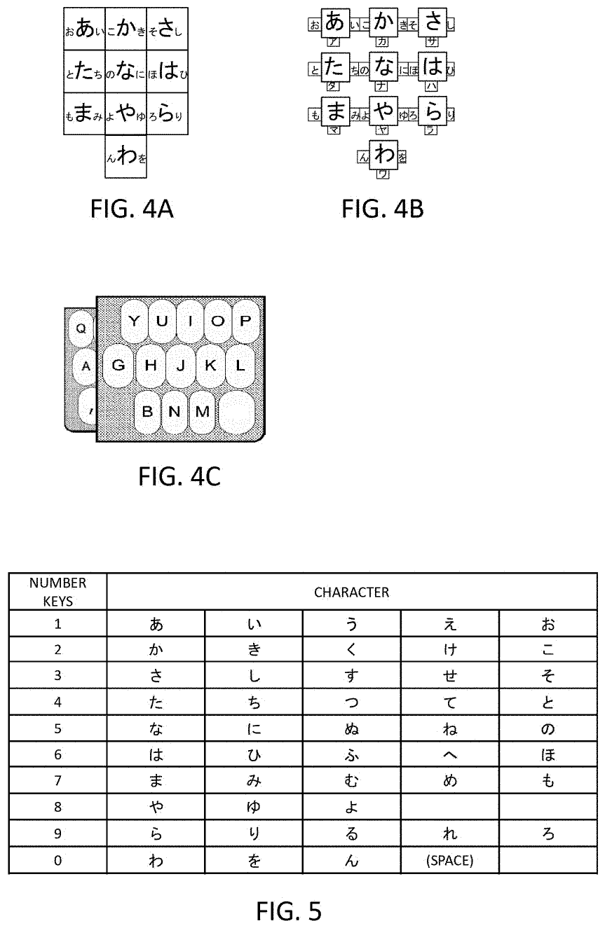

The display mode of the input buttons 1511 need only be such that the input buttons 1511 are selectable by the user, and is not limited to the mode shown in FIG. 3. For example, the input buttons 1511 may be displayed without a frame surrounding each of the input buttons 1511 as shown in FIG. 3, and also, each input button need not be in a square shape. In the input buttons 1511, for example, characters to be displayed after display switching to be described below also may be displayed. In this case, for example, as shown in FIG. 4A, the characters to be displayed after display switching may be displayed in frames surrounding the characters of the respective input buttons 1511, and selectable characters may be adapted visually recognizable with their size, color, and the like. Alternatively, as shown in FIGS. 4B and 4C, the characters to be displayed after display switching may be displayed in such a manner that they are seen as lying below (in the depth direction in these drawings) the input buttons 1511.

The display mode of the input buttons 1511 may be such that the shape, color, or the like of the display changes according to the display order of partial arrays to be described below. Specifically, for example, as shown in (A) and (B) in FIG. 11, a lower left end portion of the display region of the input buttons 1511 indicating the left segment (to be displayed first in the above-described display order) has a rounded shape unlike the remaining ends of the display region, and a lower right end portion of the display region of the input buttons 1511 indicating the right segment (to be displayed last in the above-described display order) has a rounded shape unlike the remaining ends of the display region. This allows the user to recognize that the input buttons 1511 being displayed correspond to the first (or last) partial array in the display order.

In the following, the respective arrays to be displayed as the input buttons 1511 will be described specifically.

The display unit 11 displays partial arrays included in an array group in at least one category selected from the following categories (i-1) to (iv) as the input button 1511. With the configuration in which the partial arrays in any of the following categories (i-1) to (iv) are displayed as the input buttons 1511, for example, the arrangement of the input buttons seen by the user when he/she performs character input is the arrangement that has become somewhat familiar to the user through input operations into keyboards and cellular phones. This can reduce the learning load on the user, whereby the burden of operations for searching for a character that the user wants to input can be reduced. Also, since the number of the input buttons is in a predetermined range, for example, the burden of operations required for displaying a character that the user wants to input can be reduced as compared with the case where characters are displayed one by one, and also, for example, the time required for finding a desired character can be shortened as compared with the case where characters included in the array group are displayed at the same time. Accordingly, the user's burden can be reduced.

(i-1) an array group that includes partial arrays obtained by dividing a character input array for input of kana through a multi-tap operation based on an order of display in response to input operations to respective ten number keys
(i-2) an array group that includes partial arrays obtained by dividing a character input array for input of an alphabet through a multi-tap operation based on an order of display in response to input operations to respective ten number keys
(i-3) an array group that includes partial arrays obtained by dividing a character input array for input of symbols through a multi-tap operation based on an order of display in response to an input operation to the respective ten number keys
(ii) an array group that includes partial arrays obtained by dividing a key array of a keyboard into two to four segments
(iii) an array group that includes partial arrays obtained by dividing the arrangement of kana in the Japanese syllabary table into two to four segments
(iv) an array group that includes partial arrays obtained by dividing arrangement of alphabet letters in alphabetical order into two to four segments

(i-1) An array group that includes partial arrays obtained by dividing a character input array for input of kana through a multi-tap operation based on an order of display in response to input operations to respective ten number keys

In the present example, the “partial arrays obtained by dividing a character input array for input of kana through a multi-tap operation based on an order of display in response to input operations to respective ten number keys” also can be referred to as, for example, partial arrays including the respective rows of kana in the Japanese syllabary table. A specific “character input array for input through a multi-tap operation” is not particularly limited, and may be one that has been used conventionally. Also, for example, the character input array may be any of those that have been used before the user performs data input using the data input device 10 of the present invention. For example, in the case where the data input device 10 is configured such that character input through a multi-tap operation is also applicable thereto, an array for the character input through a multi-tap operation can be referred to as “a character input array for input through a multi-tap operation”. FIG. 5 shows an example of the “character input array for input of kana through a multi-tap operation”. The “order of display in response to input operations to the respective ten number keys” is, for example, the order counted from the left in FIG. 5. “Kana” may be, for example, hiragana, katakana, syllables beginning with voiced consonants, syllables beginning with p-sound, small characters (used to represent syllables with palatalized consonants and double consonants), or half-width characters.

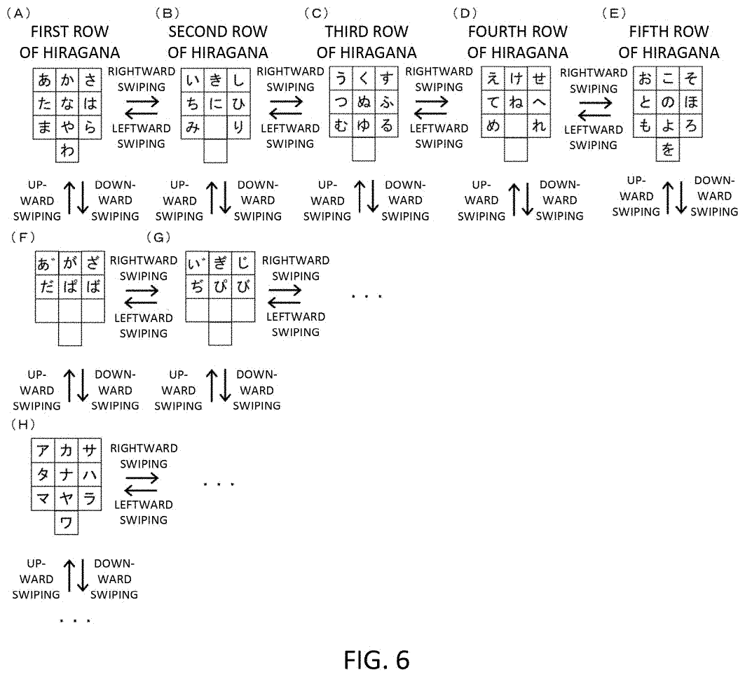

Examples of a partial array indicating the first row of hiragana include those shown in FIGS. 3, 5, and 6. Partial arrays including the second to fifth rows of hiragana may be, for example, those shown in FIG. 5 or those shown in FIG. 6. As described below, these partial arrays may be misaligned to the extent that it does not cause a burden on the user, and other characters (e.g., characters that are not included in the first to fifth rows of hiragana) may be added to any of the partial arrays.

Note here that hiragana (those beginning with unvoiced consonants), katakana, syllables beginning with voiced consonants, syllables beginning with p-sound, small characters, half-width characters, and the like may be included in different array groups, respectively, or all of them may be included in a single array group. In the former case, for example, an array group that includes partial arrays respectively including the first to fifth rows of hiragana is different from an array group that includes partial arrays respectively including the first to fifth columns of katakana. In the latter case, for example, a partial array indicating the first row of hiragana may include, e.g., (P1) and (P2) exemplified in Table 1 below. As described above, in the present example, the number of input buttons used as the “character input array for input through a multi-tap operation” is not limited to 10 (corresponding to 1 to 0), and may be larger than 10 or may be smaller than 10 in the case of lack of character to be assigned to the input buttons. In this case, the arrangement of the characters assigned to the input buttons may be similar to or different from the arrangement in the character input array for input of kana through a multi-tap operation (e.g., the above-described arrangement in four rows and three columns). Also, in the latter case, for example, by employing an arrangement maintaining the order of each column of hiragana, the user's burden for character search can be reduced.

FIG. 6 shows an example of the input buttons 1511 displayed in the button display section 151 in the present example. In FIG. 6, (A) to (E) show the states where partial arrays indicating the first to fifth rows of hiragana are displayed, respectively, (F) and (G) show the states where partial arrays indicating the first and second rows of hiragana with the voicing mark are displayed, respectively, and (H) shows the state where a partial array indicating the first row of katakana is displayed. In FIG. 6, the partial arrays indicating hiragana ((A) to (E) in FIG. 6), the partial arrays indicating the syllables beginning with voiced consonants and p-sound ((F) and (G) in FIG. 6), and the partial array indicating katakana ((H) in FIG. 6) are included in different array groups, respectively.

In the drawings to be described below, as examples of an input operation in a first direction and an input operation in a second direction to be described below, input operations through swiping such as “rightward swiping” are shown. However, in the present invention, the input operation in the first direction and the input operation in the second direction are not limited thereto. Also, in the drawings, arrows indicating switching operations are shown between the respective partial arrays. However, they are merely illustrative examples, and the present invention is not limited thereto. For example, the present invention does not exclude switching operations in oblique directions, further switching of the partial arrays displayed at the ends, and the like.

In the state where the partial arrays with the voicing mark are displayed as shown in (F) and (G) in FIG. 6, the display of the input buttons corresponding to the columns of hiragana not to be combined with the voicing mark is not particularly limited. For example, these input buttons may display syllables beginning with unvoiced consonants, may display these syllables with the voicing mark (e.g., in FIG. 6, the first column of hiragana), may be shown as blank input buttons (e.g., in FIG. 6, the seventh to tenth column of hiragana), or may display other input buttons (in FIG. 6, the fifth column of hiragana). In (F) and (G) in FIG. 6, instead of syllables in the fifth column of hiragana, syllables that are in the sixth column of hiragana and begin with p-sound are displayed as the above-described other input buttons. Like this, the arrangement of characters may be misaligned from the character input array for input through a multi-tap operation to the extent that it does not cause a burden on the user. The blank input buttons may be adapted such that the user can set any desired characters to be displayed therein.

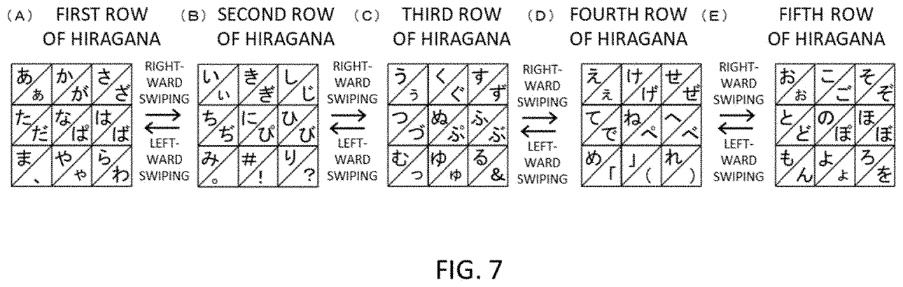

FIG. 7 shows another example of the input buttons 1511 displayed in the button display section 151 in the present example. In FIG. 7, (A) to (E) show the states where partial arrays indicating the first to fifth rows of hiragana are displayed, respectively. In (A) to (E) in FIG. 7, the partial arrays include, in addition to the syllables in the first to tenth columns of kana, other characters (characters that are not included in the first to tenth columns of kana), punctuation marks, symbols, and the like.

(i-2) An array group that includes partial arrays obtained by dividing a character input array for input of an alphabet through a multi-tap operation based on an order of display in response to input operations to respective ten number keys

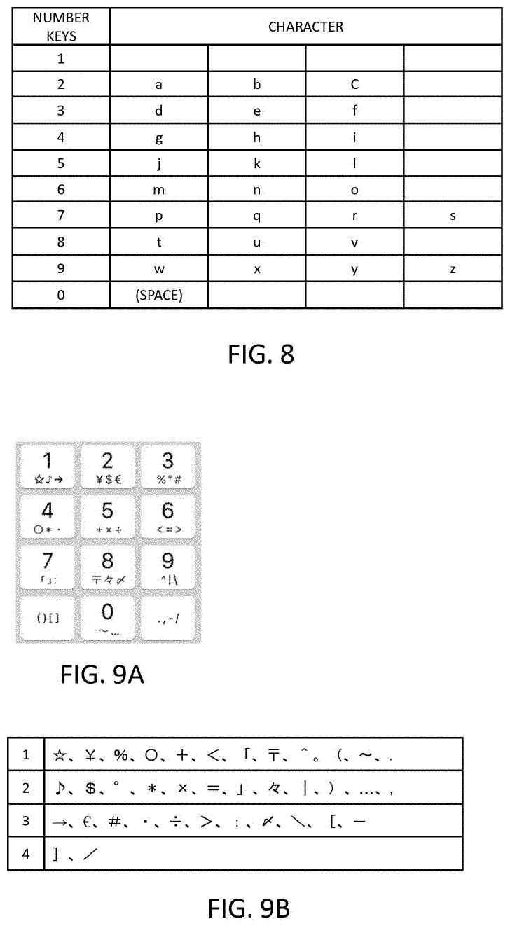

In the present example, the “character input array for input of an alphabet through a multi-tap operation” may be, for example, an array according to ITU-T Recommendation E.161. FIG. 8 shows an example of the “character input array for input of an alphabet through a multi-tap operation”. The “order of display in response to input operations to the respective ten number keys” is, for example, the order counted from the left in FIG. 8. The partial arrays that indicates an alphabet according to ITU-T Recommendation E.161 is, for example, “a, d, g, j, m, p, t, w, (space)” (a-column), “b, e, h, k, n, q, u, x” (b-column), “c, f, i, l, o, r, v, y” (c-column), and “s, z” (s-column). In the case where there is no alphabet letter to be displayed, the display of the corresponding input button 1511 is not particularly limited. For example, the corresponding input button 1511 may be blank or may display another alphabet letter, or another input button may be displayed. For example, it is common to assign symbols to the number key “1”. Accordingly, the number key “1” may similarly display symbols.

The “alphabet” may be the one corresponding to the language of each country. Also, lower-case letters and upper-case letters of the “alphabet”, characters in different fonts, bold characters, italicized characters, underlined characters, struck-out characters, characters with ring above or with diaeresis, corresponding characters in a different language (e.g., Greek), and the like may be, for example, included in different array groups, respectively, or all of them may be included in a single array group.

The “character input array for input of an alphabet through a multi-tap operation” may further include, for example, a partial array indicating numbers.

(i-3) An array group that includes partial arrays obtained by dividing a character input array for input of symbols through a multi-tap operation based on an order of display in response to an input operation to the respective ten number keys

In the present example, the “character input array for input of symbols through a multi-tap operation” may be, for example, an array shown in FIG. 9A. The “order of display in response to input operations to the respective ten number keys” is, for example, in FIG. 9A, the order of symbols shown below each number of the number keys, counted from the left. The partial arrays indicating symbols may be, for example, those shown in the table of FIG. 9B. The partial array assigned to “4” in the table of FIG. 9B may be incorporated in the partial arrays assigned to “1” to “3” to the extent that it does not cause a burden on the user, for example.

The “character input array for input of symbols through a multi-tap operation” may further include a partial array indicating numbers as shown in FIG. 9A, for example.

(ii) An array group that includes partial arrays obtained by dividing a key array of a keyboard into two to four segments

In the present invention, the “key array of a keyboard” is not particularly limited, and may be, for example, a key array that displays a list of characters as in the QWERTY layout or the like and a symbol and number key array utilizing the button arrangement in the QWERTY layout or the like. A specific “key array of a keyboard” is not particularly limited, and may be one that has been used conventionally. Also, for example, the character input array may be any of those that have been used before the user performs data input using the data input device 10 of the present invention. Examples of the “key array of a keyboard” include key arrays of virtual keyboards. Further, for example, when the data input device 10 also can display an undivided key array of a keyboard, the undivided key array of a keyboard can be referred to as a “key array of a keyboard”.

In the present invention, “partial arrays obtained by dividing a key array” is not limited to those obtained by equally dividing the original key array. A partial array need only be such that the user perceives that the partial array is obtained by dividing the original key array and also such that, when the user searches for a desired character, the user can use the original key array as reference information and thus can find the desired character with a smaller burden as compared with the case where the user searches for the desired character out of randomly arranged characters. Within the range where the above conditions are satisfied, the partial arrays may include a character(s) common to these partial arrays. The direction along which the key array is divided is not limited to a vertical direction, and the key array may be divided along a vertical direction and a horizontal direction, for example. “Partial arrays obtained by dividing a key array” also can be referred to as “substantially divisional arrays”.

The array group included in the category (ii) may be, for example: (1) an array group that includes partial arrays obtained by dividing a key array of a keyboard employing the QWERTY layout into two to four segments; and (2) an array group that includes partial arrays obtained by dividing a symbol and number key array of a keyboard into two to four segments.

(1) An array group that includes partial arrays obtained by dividing a key array of a keyboard employing the QWERTY layout into two to four segments

In the present invention, the term “QWERTY layout” is used in a broad sense and encompasses layouts derived from the QWERTY layout, such as the QWERTZ layout and the AZERTY layout. The term also encompasses, for example, a button arrangement that includes symbols, characters, and the like corresponding to the language of each country, in addition to the button arrangement of the QWERTY layout. Further, for example, characters such as numbers and symbols arranged around the key array of the QWERTY layout in a keyboard also may be included.

The “alphabet” included in the “QWERTY layout” is as described above. Also, lower-case letters and upper-case letters of the “alphabet”, characters in different fonts, bold characters, italicized characters, underlined characters, struck-out characters, characters with ring above or with diaeresis, corresponding characters in a different language (e.g., Greek), and the like may be, for example, included in different array groups, respectively, or all of them may be included in a single array group. Also in the latter case, it is preferable to devise a method for allowing the user to easily recognize that partial arrays that the user sees are the above-described partial arrays by, for example, setting the arrangement of the characters assigned to the input buttons to be similar to the key array of a keyboard employing the QWERTY layout.

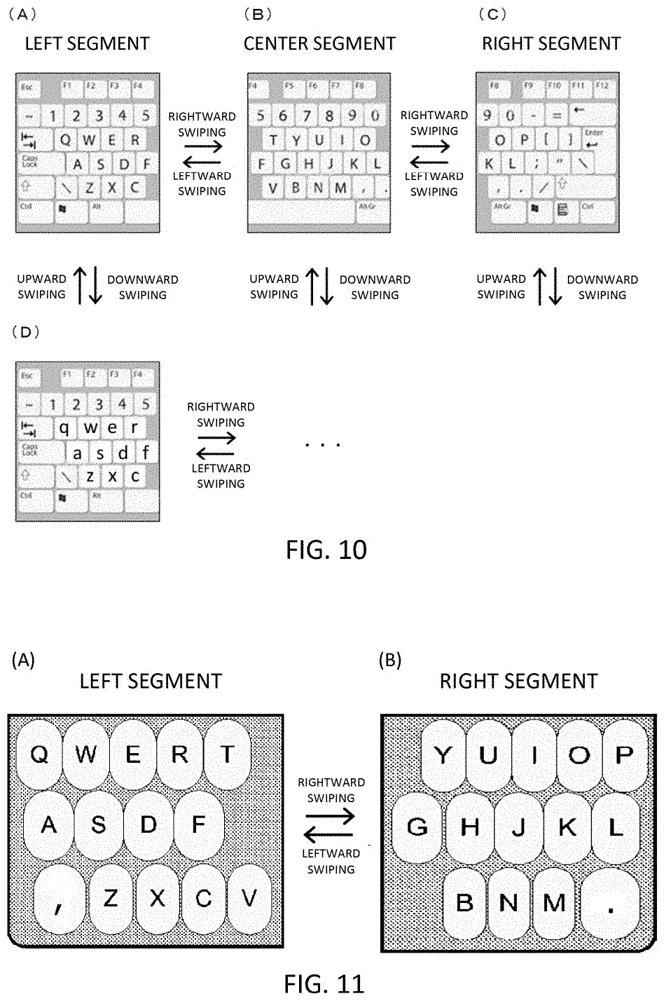

FIG. 10 shows an example of the input buttons 1511 displayed in the button display section 151 in the present example. In FIG. 10, (A) shows the state where, out of partial arrays that are obtained by dividing a key array of the QWERTY layout into three segments and indicate upper-case letters, a partial array indicating the left segment is displayed, (B) shows the state where, out of the above-described partial arrays, a partial array indicating the center segment is displayed, (C) shows the state where, out of the above-described partial arrays, a partial array indicating the right segment is displayed, and (D) shows the state where, out of partial arrays that are obtained by dividing the QWERTY layout into three segments and indicate lower-case letters, a partial array indicating the left segment is displayed. In FIG. 10, an array group that includes the partial arrays indicating upper-case letters ((A) to (C) in FIG. 10) is different from an array group that includes the partial array indicating lower-case letters ((D) in FIG. 10). In FIG. 10, the respective partial arrays include one or more characters common to each other. In FIG. 10, in addition to the alphabet in the QWERTY layout, characters such as numbers and symbols arranged around the key array of a keyboard employing the QWERTY layout are also displayed.

FIG. 11 shows another example of the input buttons 1511 displayed in the button display section 151 in the present example. In FIG. 11, (A) shows the state where, out of partial arrays obtained by dividing a key array of the QWERTY layout into two segments, a partial array indicating the left segment is displayed, and (B) shows the state where, out of the above-described partial arrays, a partial array indicating the right segment is displayed. In (A) and (B) in FIG. 11, as the input buttons 1511, comma and period are displayed in addition to the alphabet in the QWERTY layout.

In (A) and (B) in FIG. 11, the display region of the input buttons 1511 has a rounded shape in a lower end portion either on the left or on the right. This allows the user to recognize that the input buttons 1511 being displayed correspond to the first or last partial array in the display order, which will be described below.

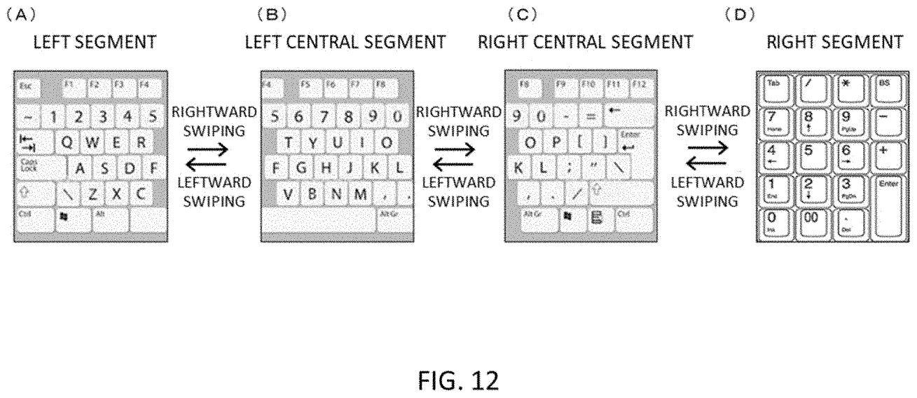

FIG. 12 shows still another example of the input buttons 1511 displayed in the button display section 151 in the present example. In FIG. 12, (A) shows the state where, out of partial arrays obtained by dividing a key array of the QWERTY layout into four segments, a partial array indicating the left segment, (B) shows the state where, out of the above-described partial arrays, a partial array indicating the left central segment, (C) shows the state where, out of the above-described partial arrays, a partial array indicating the right central segment, and (D) shows the state where, out of the above-described partial arrays, a partial array indicating the right segment.

(2) An array group that includes partial arrays obtained by dividing a symbol and number key array of a keyboard into two to four segments

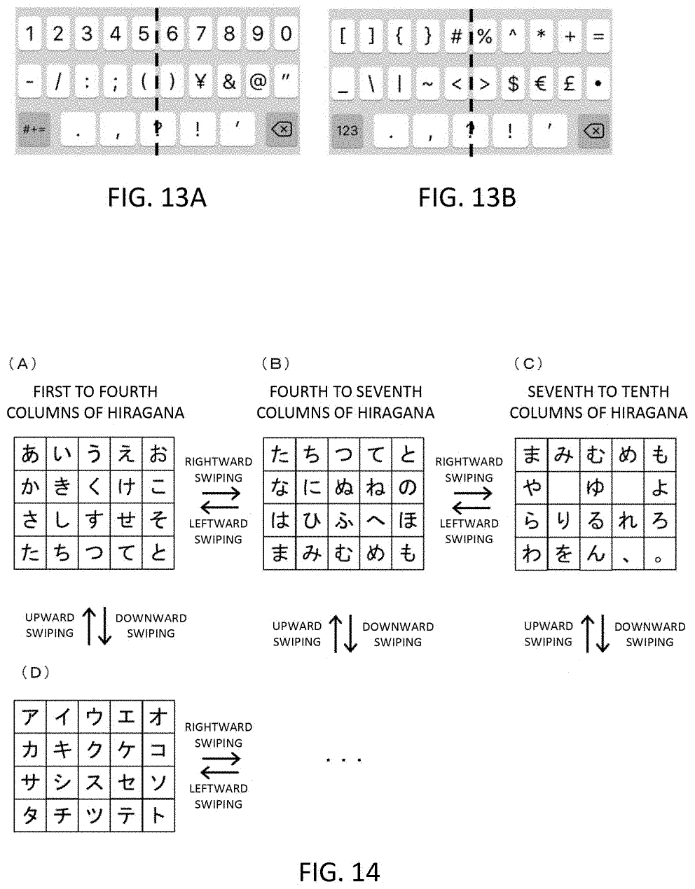

In the present invention, the “symbol and number key array of a keyboard” is as described above. FIGS. 13A and 13B show an example of the “symbol and number key array of a keyboard”. The input buttons 1511 displayed in the button display section 151 may indicate, for example, partial arrays obtained by dividing the key arrays shown in FIGS. 13A and 13B as appropriate at positions indicated with the dotted lines in FIGS. 13A and 13B, for example. Array groups corresponding to FIGS. 13A and 13B are array groups different from each other.

(iii) An array group that includes partial arrays obtained by dividing the arrangement of kana in the Japanese syllabary table into two to four segments

In the present invention, “the arrangement of kana in the Japanese syllabary table” need only be such that the user perceives the arrangement maintains the common order of syllables in the Japanese syllabary table, and also such that, when the user searches for a desired character, the user can use the original arrangement as reference information and thus can find the desired character with a smaller burden as compared with the case where the user searches for the desired character out of randomly arranged characters. That is, in the present invention, “the arrangement of kana in the Japanese syllabary table” may be the arrangement in which the first to fifth rows of kana are arranged in either the vertical direction or the horizontal direction, and the first column of kana may start from any of the left side, right side, upper side, and lower side. “Kana” may be, for example, hiragana, katakana, syllables beginning with voiced consonants, syllables beginning with p-sound, small characters, or half-width characters, as described above.

As described above, hiragana (those beginning with unvoiced consonants), katakana, syllables beginning with voiced consonants, syllables beginning with p-sound, small characters, half-width characters, and the like may be included in different array groups, respectively, or all of them may be included in a single array group. In the latter case, “the arrangement of kana in the Japanese syllabary table” may be such that, for example, the first row of kana is arranged in the orders (P3) to (P5) exemplified in Table 2. Also in this case, since the characters assigned to the input buttons are arranged based on the arrangement of only the syllables beginning with unvoiced consonants in the Japanese syllabary table, the user can recognize that partial arrays that the user sees are the above-described partial arrays.

FIG. 14 shows an example of the input buttons 1511 displayed in the button display section 151 in the present example. In FIG. 14, an array group includes partial arrays obtained by dividing the arrangement of kana in the Japanese syllabary table into three segments. In FIG. 14, (A) shows the state where a partial array indicating the first to fourth columns of hiragana is displayed, (B) shows the state where a partial array indicating the fourth to seventh columns of hiragana is displayed, (C) shows the state where a partial array indicating the seventh to tenth columns of hiragana is displayed, and (D) shows the state where a partial array indicating the first to fourth columns of katakana is displayed. In FIG. 14, an array group that includes the partial arrays indicating hiragana ((A) to (C) in FIG. 14) is different from an array group that includes the partial array indicating katakana ((D) in FIG. 14). However, the present invention is not limited thereto. In FIG. 14, the respective partial arrays include characters common to each other. In (C) in FIG. 14, punctuation marks are displayed in addition to the characters included in the Japanese syllabary table.

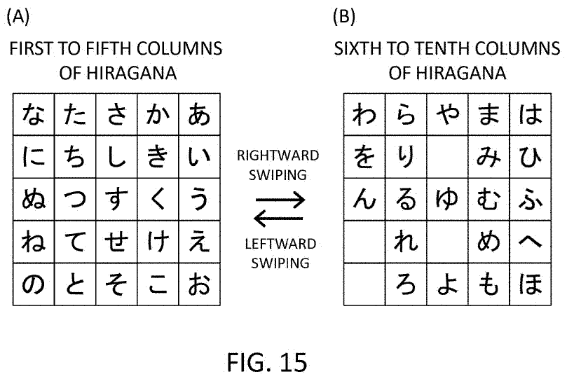

FIG. 15 shows another example of the input buttons 1511 displayed in the button display section 151 in the present example. In FIG. 15, an array group includes partial arrays obtained by dividing the arrangement of kana in the Japanese syllabary table into two segments. In FIG. 15, (A) shows the state where a partial array indicating the first to fifth columns of hiragana is displayed, and (B) shows the state where a partial array indicating the sixth to tenth columns of hiragana is displayed.

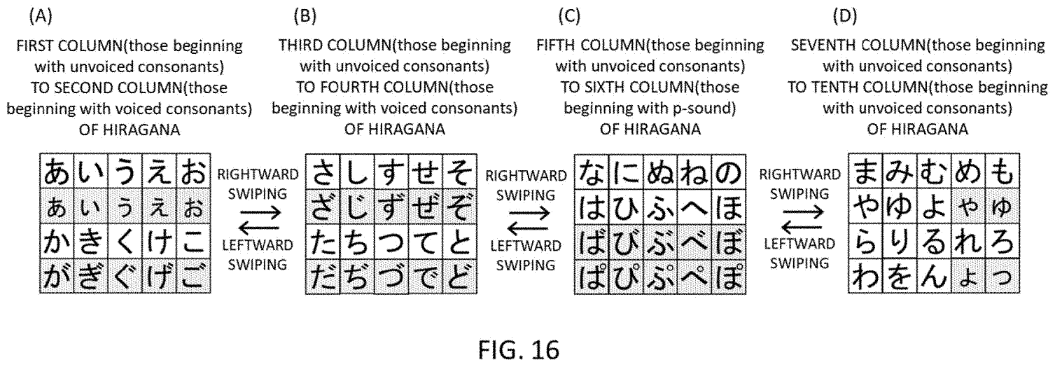

FIG. 16 shows still another example of the input buttons 1511 displayed in the button display section 151 in the present example. In FIG. 16, an array group includes partial arrays obtained by dividing the arrangement of kana in the Japanese syllabary table into four segments. In FIG. 16, (A) shows the state where a partial array indicating the first column of hiragana (those beginning with unvoiced consonants), the first column of hiragana (small characters), the second column of hiragana (those beginning with unvoiced consonants), and the second column of hiragana (those beginning with voiced consonants) is displayed, (B) shows the state where a partial array indicating the third column of hiragana (those beginning with unvoiced consonants), the third column of hiragana (those beginning with voiced consonants), the fourth column of hiragana (those beginning with unvoiced consonants), and the fourth column of hiragana (those beginning with voiced consonants) is displayed, (C) shows the state where a partial array indicating the fifth column of hiragana (those beginning with unvoiced consonants), the sixth column of hiragana (those beginning with unvoiced consonants), the sixth column of hiragana (those beginning with voiced consonants), and the sixth column of hiragana (those beginning with p-sound) is displayed, and (D) shows the state where a partial array indicating the seventh to tenth column of hiragana (those beginning with unvoiced consonants) are displayed. In (A) to (D) in FIG. 16, the syllables beginning with voiced consonants and p-sound and the small characters are shaded to make it easier to distinguish them from the syllables beginning with unvoiced consonants.

(iv) An array group that includes partial arrays obtained by dividing arrangement of alphabet letters in alphabetical order into two to four segments

In the present invention, the “arrangement of alphabet letters in alphabetical order” need only be such that the user perceives that the sequence maintains the common alphabetical order, and also such that, when the user searches for a desired character, the user can use the original sequence as reference information and thus can find the desired character with a smaller burden as compared with the case where the user searches for the desired character out of randomly arranged characters. That is, in the present invention, the “arrangement of alphabet letters in alphabetical order” may be the arrangement in which letters “a, b, c, d, e, . . . ” are arranged in either the vertical direction or the horizontal direction, and the letter “a” may start from any of the left side, right side, upper side, and lower side.

The “alphabet” included in the “arrangement of alphabet letters in alphabetical order” is as described above. Also, lower-case letters and upper-case letters of the “alphabet”, characters in different fonts, bold characters, italicized characters, underlined characters, struck-out characters, characters with ring above or with diaeresis, corresponding characters in a different language (e.g., Greek), and the like may be, for example, included in different array groups, respectively, or all of them may be included in a single array group. Also in the latter case, it is preferable to devise a method of allowing the user to easily recognize that partial arrays that the user sees are the above-described partial arrays by, for example, setting the arrangement of the characters assigned to the input buttons to be based on the arrangement of alphabet letters in alphabetical order.

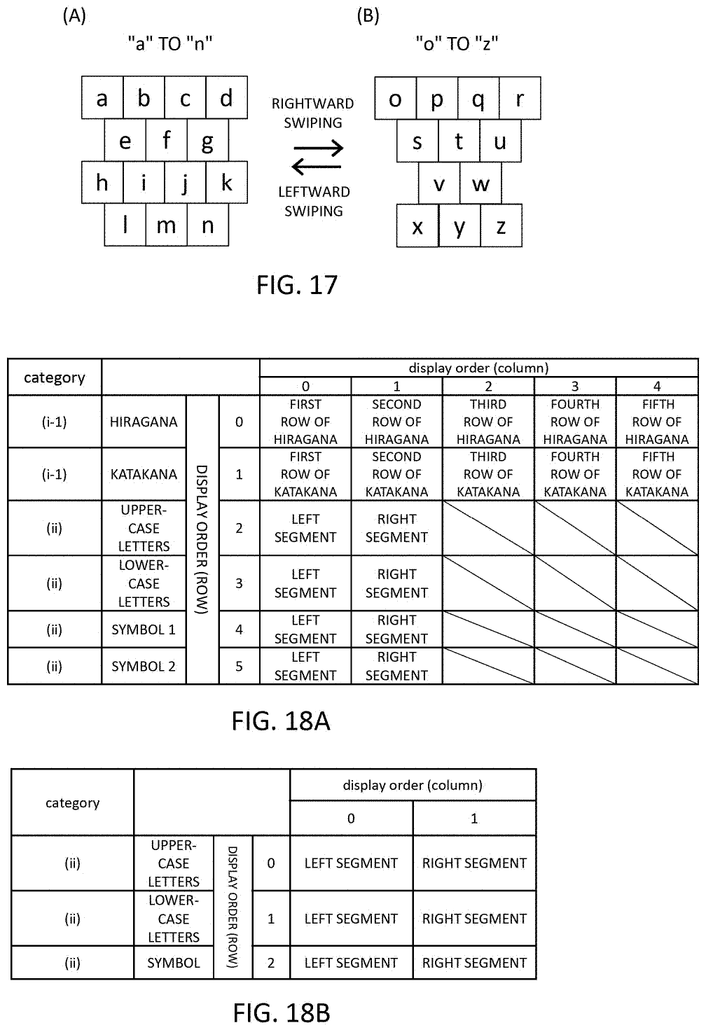

FIG. 17 shows an example of the input buttons 1511 displayed in the button display section 151 in the present example. In FIG. 17, an array group includes partial arrays obtained by dividing the arrangement of alphabet letters in alphabetical order into two segments. In FIG. 17, (A) shows the state where a partial array indicating letters a to n in alphabetical order is displayed, and (B) shows the state where a partial array indicating letters o to z in alphabetical order is displayed.

The display unit 11 performs first switching by switching the display of the input buttons 1511 in the button display section 151 in response to an input operation in the first direction to the detection section 153, and performs second switching by switching the display of the input buttons 1511 in the button display section 151 in response to an input operation in the second direction. The input operations in the first and second directions will be described below.

The first switching is switching to a different one of partial arrays in the same array group. Specifically, for example, the partial arrays shown in (A) to (E) in FIG. 6 and the partial arrays shown in (A) to (C) in FIG. 10 are different partial arrays in the same array group. The second switching is switching to one of array groups in a different category among the above-described categories (i-1) to (iv) or to a different one of the array groups in the same category.

In the “display switching” described above, for example, at the same time with the disappearance of the display of a preceding partial array in a display order to be described below, a subsequent partial array in the display order is displayed at this display position (i.e., the preceding partial array is replaced with the subsequent partial array). It is to be noted, however, that the present invention is not limited thereto, and there may be a state where a plurality of partial arrays are displayed at the same time in such a manner that these partial arrays are in selectable state. An example of such a state is that the subsequent partial array is displayed in the state where the display of the preceding partial array and the display of the subsequent partial array partially overlap with each other. Also in the latter case, after the completion of single “display switching”, the subsequent partial array is displayed at a main display position. By performing the “display switching” in the above-described manner, absolute positions at which the respective input buttons are displayed are set. As a result, the user can visualize the correspondence between the characters and their positions, whereby the user's burden for searching for a character that the user wants to input can be reduced.

By performing the “display switching” of the input buttons 1511 in response to the input operations in the first and second directions, the user can search for a desired character while performing an operation for displaying the desired character, for example. Specifically, in the case where a desired character (e.g., the letter “P”) is not displayed, the user can search for the desired character while changing the display of partial arrays (for example, in the case of the category (ii), while displaying the partial arrays obtained by dividing the key array of a keyboard into three segments in the order of the left segment, the central segment, and the right segment) even if the user does not exactly know “what operations (the number of operations, the amount of movement, etc.) he/she should perform”, and thus can find the desired character.

The display unit 11 may also switch the display of buttons other than the input buttons 1511 together with the display of the input buttons 1511, for example. Specifically, for example, the display unit 11 may switch the display of the symbol button 1512 etc. shown in FIG. 3, together with the display of the input buttons 1511.

The above-described “display switching” may be accompanied by an effect to make the switching noticeable, for example. Examples of such an effect include sound, vibration, and a predetermined display indicating that the switching has been performed. With this configuration, for example, the user can know which of the partial arrays is being displayed in the button display section 151 also with the aid of this effect, whereby the user's burden for character search can be further reduced. When the effect to make the switching noticeable is producing a sound or the like, the combination of this effect with the above-described effect of setting the absolute positions enables the user to touch-type, for example.

The display unit 11 can provide a display resulting from the first switching and a display resulting from the second switching according to their display order. Information on the display order is stored in association with the respective partial arrays, for example.

Specifically, the respective partial arrays may be associated with row information that indicates the display order resulting from the first switching and column information that indicates the display order resulting from the second switching. Then, in the first switching, the display unit can change the column information associated with a partial array being displayed without changing the row information and then display, as a partial array after the first switching, a partial array associated with the row information and column information after being thus changed, and in the second switching, when the second switching is switching to a different one of the array groups in the same category, the display unit can change the row information associated with a partial array being displayed without changing the column information, and when the second switching is switching to one of the array groups in the other categories, the display unit can change the column information of a partial array being displayed to column information at an initial position and also can change the row information, and then can display, as a partial array after the second switching, a partial array associated with the row information and column information after being thus changed. The “row information and column information” are not particularly limited as long as they indicate the display orders. The “row information and column information” are, for example, numerical values that indicate the positional information in a two-dimensional array.

FIG. 18 shows an example where display orders of partial arrays in the first switching and in the second switching are indicated with row information and column information. In the table of FIG. 18A, partial arrays included in six array groups in the categories (i-1) and (ii) (the array groups exemplified in (A) to (E) and (H) in FIG. 6, (A) and (B) in FIG. 11, and FIGS. 13A and 13B) are associated with row and column values indicating the display orders. In the table of FIG. 18B, partial arrays included in two array groups in the category (ii) (the array groups exemplified in (A) and (B) in FIG. 11 and FIG. 13B) are associated with row and column values indicating the display orders. In the following description, the terms “row” and “column” in the present example are interchangeable with each other.

The row information and the column information will be described with reference to an example where they are the ones shown in the table of FIG. 18A. In the first switching, the display unit 11 changes the “column” value of the partial array being displayed (“+1” or “−1”). For example, when the first switching is performed in the state where “the second row of hiragana (0, 1)” in the category (i-1) is displayed, “the third row of hiragana (0, 2)” in the category (i-1) is then displayed. In the second switching, the display unit 11 changes the “row” value of the partial array being displayed (“+1” or “−1”). At this time, when the second switching is, for example, switching to a different one of array groups in the same category, the display unit 11 maintains the “column” value of the display order (“±0”) and changes only the “row” value of the display order (“+1” or “−1”). For example, when the second switching is performed in the state where “the second row of hiragana (0, 1)” in the category (i-1) is displayed, “the second row of katakana (1, 1)” is then displayed. On the other hand, when the second switching is switching to one of array groups in different categories, the display unit 11 sets the “column” value of the display order to an initial position (set to “0”) and changes the “row” value of the display order (“+1” or “−1”). For example, when the second switching is performed in the state where “the second row of katakana (1, 1)” in the category (i-1) is displayed, “the left segment (2, 0)” of the category (ii) is then displayed.

In the example shown in FIGS. 18A and 18B, the first and last partial arrays in the display order in the first switching are, in the category (i-1), the partial arrays in “column 0” and “column 4”, respectively, and, in the category (ii), the partial arrays in “column 0” and “column 1”, respectively. The first and last partial arrays in the display order in the second switching are the partial arrays in “row 0” and “row 5”, respectively.

The above-described switching may be performed with respect to only the display order between the first to last partial arrays, for example. That is, after the switching has been performed until the last (or first) partial array in the display order is displayed, it is not necessary to further switch the display even if an input operation in the first direction or an input operation in the second direction is performed. On the other hand, when further input operations in the first direction and the second direction are performed, the switching may be performed to return to the display of the first (or last) partial array in the display order. In the former case, for example, when the user wants to display the last (or first) input buttons in the display order, even if the user performs an input operation vigorously (without giving consideration to the number of flicking operations or the amount of movement of a swiping operation), excessive switching to pass over the display of the desired input buttons can be prevented, thereby allowing the last (or first) input buttons in the display order to be displayed. Accordingly, the user's burden for character display operations can be further reduced. On the other hand, the latter case will be described with reference to the example shown in FIG. 12. For example, when the user wants to input “Q” included in the left segment ((A) in FIG. 12) to be displayed first and then wants to input “1” included in the right segment ((D) in FIG. 12) to be displayed last in the first switching, the desired characters can be displayed through a smaller number of operations or a smaller amount of movement.

The first switching and the second switching each may include further switching to a different array group. The above-described different array group may be the same as or different from any of the array groups in the categories (i-1) to (iv). In the former case, for example, the first switching may enable switching between the left segment ((A) in FIG. 11) and the right segment ((B) in FIG. 11) in the key array of a keyboard employing the QWERTY layout and further switching between the left segment and the right segment (FIG. 13B) of a symbol key array of a keyboard.

The display unit 11 may perform the respective switchings in the same manner or in different manners. In the latter case, for example, the switchings may include smooth switching and switching with some difficulty. Such switchings can be set by, for example, adjusting the time periods from input to the second detection unit 14 to the switchings or the amounts of movement of operations required for performing the switchings. Also, for example, instead of the above-described effect to make the switching noticeable, such as producing a sound, a different effect may be employed. By performing the respective switchings in different manners as described above, for example, in the case of switching performed after returning to the first (or last) partial array in the display order, the case of switching to one of the array groups in the other categories, the case of switching to still another different array group, and the like, is possible to notify the user which switching is being performed.

The display unit 11 may perform third switching by, for example, switching the display of the input buttons 1511 in the button display section 151 in response to an input operation in a third direction to the second detection unit 14. The input operation in the third direction will be described below. As a result of the third switching, for example, an array group that is the same as or different from any of the array groups in the categories (i-1) to (iv) may be displayed.

The switching of the display of the input buttons 1511 also may be achieved by, for example, any input operation other than the input operations in the first and second directions to the detection section 153. For example, in FIG. 3, by selecting the lower-case button 1513, the display of the input buttons 1511 can be changed to small characters. Further, by selecting the number, alphabet, and kana switching buttons 1514A to 1514C, the display of the input buttons 1511 can be changed to a display corresponding thereto.

The first detection unit 12 detects a selection from the input buttons 1511 by the user. The user can perform operations for the selection with his/her fingers 1001A and 1001B or using a stylus or the like, for example.

The method for making a selection from the input buttons 1511 is not particularly limited, and can be set as appropriate according to the type of the device that displays the input buttons 1511, the type of the button display section 151, and the like. The operation for making a selection from the input buttons 1511 is preferably an operation that is different from the input operations in the first and second directions to the detection section 153. That is, for example, tapping is assigned to the selection from the input buttons 1511, and an operation that involves moving a touch, such as flicking or swiping, is assigned to the input operations in the first and second directions. Assigning the operations as described above is beneficial to the user because this allows the same type of operation to more closely correspond to the same type of action. It is to be noted, however, that the same operation may be assigned to both the selection from the input buttons 1511 and the input operations in the first and second directions. Specifically, the selection from the input buttons 1511 also can be performed through an operation such as flicking or swiping (e.g., drawing an oblique line on the selected input button 1511 or surrounding the selected input button 1511 with a circle). As described below, in the present embodiment, the button display section 151 in the touch panel 15 also serves as the detection section 153. In this case, for example, an input button, operations, and the like may be set to enable switching of these sections when performing input operations thereto. Also, another operation such as long press may be combined with flicking, swiping, or the like. Further, for example, the present invention may be adapted such that a second touch for character selection can be input only in the state where a first touch for display switching is maintained.

The input unit 13 performs data input according to the selected input button. The data input is not particularly limited, and can be performed in a manner similar to those in known character input devices. As shown in FIG. 3, the input unit 13 displays the selected character in an input data display section 152 according to the selected input button, for example. In the data input, for example, the input unit 13 may display the selected character in a temporarily selected state in the input data display section 152. Thereafter, as shown in FIG. 3, when the enter button 1517 or any of input candidates displayed in the candidate display section 1518 based on the temporarily selected character is selected by the user, the temporarily selected character or the conversion candidate may be confirmed.

The second detection unit 14 detects an input operation in a first direction to the detection section 153 by the user and an input operation in a second direction that is different from the first direction to the detection section 153 by the user. As shown in FIG. 3, in the present embodiment, the button display section 151 in the touch panel 15 also serves as the detection section 153. Thus, examples of the input operations include those exemplified above in the description regarding the first detection unit 12, and the input operations can be performed with the user's fingers 1001A and 1001B or using a stylus or the like, for example. However, as described below, the present invention is not limited thereto.

The input operations in the first and second directions are not particularly limited. For example, when the detection section 153 is a touch panel, they may be flicking and swiping. Also, as described below, the input operations in the first and second directions each may be achieved through an operation of moving a stick, an operation of moving a mouse or a laser pointer, an operation of a finger on a mouse, an operation of a mouse wheel, an input operation by moving the direction of eyes, or the like, or alternatively, through an operation of moving (e.g., shaking) the data input device 10 itself. As described above, it is preferable that the user performs the input operations in the first and second directions by moving his/her body part (e.g., fingers, hand, body, or the direction of eyes) or a stylus in the directions of the input operations. With the above-described configuration, for example, the input operations in the first and second directions (input operations through movement in the predetermined directions) can be distinguished from the operation for making a selection from the input buttons 1511 (an input operation by selecting a point). Accordingly, the user can switch his/her mind when performing these distinct operations, whereby the psychological burden when the user performs these operations can be further reduced. However, the present invention is not limited thereto, and the input operations in the first and second directions may be, for example, touching a mark such as an arrow indicating each direction or pressing a button on a D-pad.

For example, as shown in FIG. 3, the user may perform the input operations in the first and second directions with the finger 1001B of his/her left hand and perform the selection from the input buttons 1511 with the finger 1001A of his/her right hand. By assigning the operations as described above, a character display operation for displaying different characters and a character selection operation for selecting a character can be separately assigned to the user's right hand and left hand. This not only allows these operations to be performed at the same time but also further reduces the burden of each operation. That is, for example, the finger 1001A of the right hand is used only for the “selection” from the displayed characters, whereby the burden on the finger 1001A can be reduced. However, the present invention is not limited thereto. The user may optionally switch the correspondence between the fingers or the like and the operations. Also, the user may perform these operations using one finger or the like.

The first direction and the second direction are not particularly limited as long as they are directions different from each other. In FIG. 3, a crosswise direction is the first direction, and a vertical direction orthogonal to the crosswise direction is the second direction. Alternatively, for example, the crosswise direction may be the second direction, and the vertical direction may be the first direction. Any other combination of directions is also applicable as the combination of the first direction and the second direction. The inventor of the present invention found that, in mobile devices such as a smartphone, a direction in which users can easily move his/her fingers or a stylus is the vertical direction. On this account, in the mobile device, it is considered preferable to set the vertical direction to the first direction along which the user performs operations more frequently and set the crosswise direction to the second direction. On the other hand, when the partial arrays are those obtained by dividing the original array as in the case of the category (ii) and the like, for example, the first direction and the second direction may be set so as to allow the user to intuitively understand these directions based on the direction along which the original array is divided.

For example, when an input operation in an oblique direction (a direction that is not parallel to either the first direction or the second direction) is performed, the second detection unit 14 may correct the oblique direction so as to correspond to either the first direction or the second direction by a known method, or may process this input operation as an input operation that combines the input operations in the first and second directions. In the latter case, for example, the display unit 11 may perform both the first switching and the second switching in response to the above-described display switching performed once.

The second detection unit 14 may or may not determine the “direction of movement” (e.g., “from left to right”) in the first direction and the second direction. In the case where the “direction of movement” is determined, for example, even when the user performs an excessive switching operation by mistake, the user can perform a switching operation for undoing the excessive switching operation. On the other hand, in the case where the “direction of movement” is not determined, the design and the like of the detection section 153 and the second detection unit 14 can be simplified, for example. In the case where the “direction of movement” is not determined, for example, as to the terms “right and left” and “upper and lower” distinguished from each other in the descriptions regarding the present embodiment and the like, it can be considered that they need not be distinguished from each other or only either one of them is referred to.

The second detection unit 14 may detect the presence or absence of input operations in the first and second directions to the detection section 153. Specifically, when the input operations in the first and second directions are performed through flicking, for example, a preceding or subsequent partial array in the display order is displayed in response to the detection of single flicking.

The second detection unit 14 may detect the amount of movement of each of the input operations in the first and second directions to the detection section 153. The amount of movement is, for example, an amount having a size and a direction. Specific examples of the amount of movement include the amount of movement of a touch operation and the amount of movement of a stick, such as the position or inclination of the stick. The amount of movement may be, for example, the amount of movement from the position at which the input operation such as a touch is started or from a predetermined reference position. Specifically, when the input operations in the first and second directions are performed through swiping, for example, the amount of swiping movement is detected and a preceding or subsequent partial array in the display order is displayed according to the amount of movement.

When the amount of movement is to be detected, for example, the first switching to be performed once and the second switching to be performed once may correspond to a predetermined amount of movement of the input operation in the first direction and a predetermined amount of movement of the input operation in the second direction (for example, the amount of movement a and the amount of movement b), respectively, and the display unit 11 may perform the above-described switching of the display of the input buttons according to the amounts of movement detected by the second detection unit 14. That is, when the second detection unit 14 detects the amount of movement 3a, the display unit 11 performs the first switching three times, and when the second detection unit 14 detects the amount of movement 3b, the display unit 11 performs the second switching three times. The above-described switchings may be performed every time the predetermined amounts of movement (e.g., the amount of movement a and the amount of movement b) are detected. Alternatively, after the above-described amounts of movement (e.g., the amount of movement 3a and the amount of movement 3b) have been detected, the switchings corresponding to the detected amounts of movement may be performed.

When the display of the input buttons is switched according to the above-described amounts of movement, the amounts of movement required to display the first to last partial arrays in the display order in the first switching and the second switching are each preferably within a predetermined distance. The predetermined distance may be, for example, the movable range of the finger 1001B in the first direction or the second direction, the size of the detection section 153, and, when the detection section is a movable portion of a stick or the like as will be described below, the movable range of the detection section. Accordingly, the predetermined amount of movement P required for the above-described each switching to be performed once preferably satisfies the formula P≤X/(n−1), where X is the predetermined distance and n is the number of first to last partial arrays in the display order in the first switching or the second switching. By setting the amount of movement as described above, for example, it is possible to display the first to last partial arrays in the display order through a single input operation, whereby the user's burden for displaying a desired character can be reduced.

When the display of the input buttons is switched according to the amounts of movement as described above, the user can sequentially perform operations for making selections from the input buttons 1511 with the thumb or the forefinger 1001A of his/her right hand while continuing an operation using the thumb of his/her left hand (without releasing the thumb), for example. Accordingly, the user can input a plurality of characters more quickly, for example. This can further reduce the user's burden for character display operations and character search when the user inputs a plurality of characters continuously. Furthermore, since the predetermined distance corresponds to switching to be performed once, the user can visually grasp the amount of movement required for achieving the desired switching more easily as compared with the case where a predetermined period of time or the number of operations corresponds to the switching to be performed once, for example. Accordingly, for example, the occurrence of erroneous operation can be reduced, and also, the user's burden for character display operations can be further reduced. Moreover, when the amount of movement toward a predetermined direction corresponds to the above-described switching to be performed once, for example, as compared with the case where a predetermined period of time or the number of operations corresponds to the switching to be performed once, even if there is an erroneous operation, the user can address this erroneous operation by performing an input operation in the opposite direction while continuing the input operation, whereby the user's burden for character display operations can be further reduced.

In the present embodiment, as described above, the button display section 151 in the touch panel 15 also serves as the detection section 153. By providing the button display section 151 and the detection section 153 in a common region as described above, the necessity of providing separate regions for the button display section 151 and the detection section 153 is eliminated, resulting in space saving. Further, during the input operations in the first and second directions and the selection from the input buttons, the amount of movement of the finger or the like and the amount of movement of the direction of eyes can be reduced, whereby the user's burden in these operations can be reduced. When the common region is used as the button display section 151 and the detection section 153, the region used as the detection section 153 may be, for example, narrower than, the same as, or broader than the region used as the button display section 151. The entire region of the touch panel 15 may be used as the detection section 153, for example.

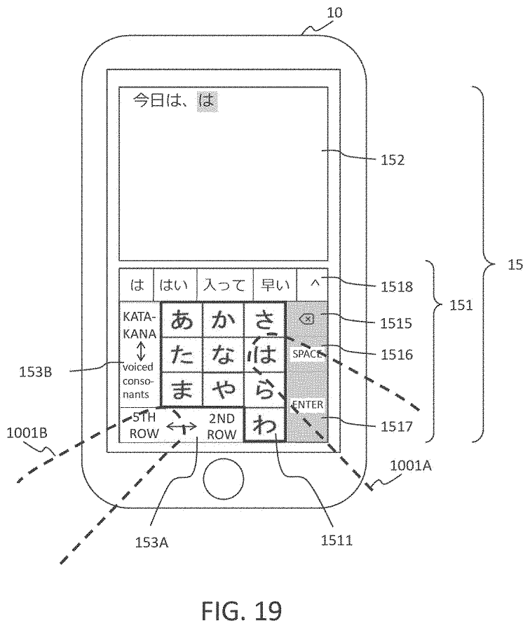

On the other hand, as shown in FIG. 19, the detection section 153 may be provided as a region different from the button display section 151 (in FIG. 19, a region including input buttons 1511, a character delete button 1515, a space/conversion button 1516, a linefeed/enter button 1517, and a candidate display section 1518). In the case where the button display section 151 and the detection section 153 are provided as different regions in the touch panel 15, for example, when the user touches the detection section 153 with his/her finger or the like, the display on the button display section 153 is unlikely to be obstructed with the finger or the like. Accordingly, the user's burden for character search can be reduced. In this case, the detection section 153 may be, for example, a region where only input operations in the first and second directions are possible, or may have any other functions.

As shown in FIG. 19, in the detection section 153, a region where an input operation in the first direction is possible (a detection section 153A) and a region where an input operation in the second direction are possible (a detection section 153B) may be provided separately, for example. In FIG. 19, in each of the detection sections 153A and 153B, a guide indicating information on switching is shown using arrows and texts.

As described above, the second detection unit 14 may further detect, for example, an input operation in the third direction to the detection section 153 by the user. The third direction is a direction different from the first and second directions. The third direction may be, for example, a direction orthogonal to a plane including two straight lines extending in the first and second directions. That is, the third direction may be the depth direction in FIG. 3, for example. An input operation in the third direction may be performed by, for example, pressing a button or pushing down a stick.

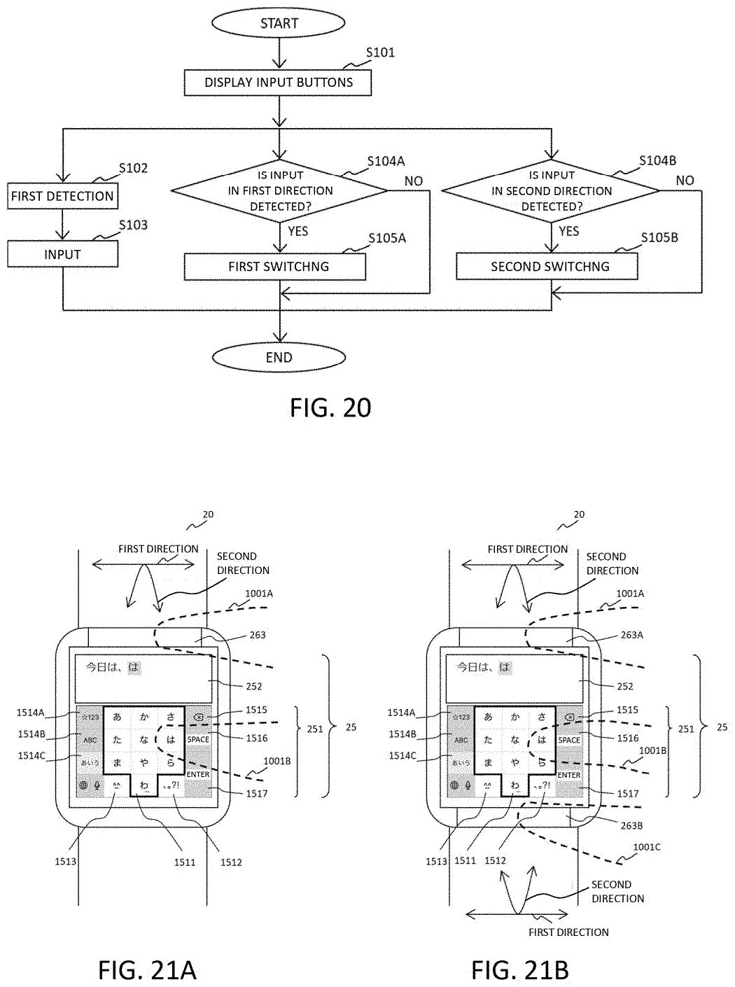

Next, an example of processing in a data input method according to the present embodiment will be described with reference to the block diagram of FIG. 1, the flowchart of FIG. 20, and an example of a display screen in the data input device (mobile device) 10 shown in FIG. 3. The data input method of the present embodiment includes a display step (S101), a first detection step (S102), an input step (S103), a second detection step (S104), and a switching step (S105), and can be performed in the following manner using the data input device 10 shown in FIG. 1, for example. The data input device 10 shown in FIG. 1 need not necessarily be used to perform the data input method of the present embodiment. The order of performing the steps (S102) to (S105) after the step (S101) is not particularly limited, and the steps (S102) to (S105) may be performed in response to input operations by the user, for example. Also, the steps (S102) to (S105) may be performed repeatedly. Furthermore, the steps (S102) and (S103) can be performed concurrently with the steps (S104) to (S105), for example.

First, the display unit 11 displays the input buttons 1511 in a plurality of rows and columns in the button display section 151, as shown in FIG. 3 (S101).

Next, the first detection unit 12 detects a selection from the input buttons by a user (S102).

Then, the input unit 13 performs data input according to the selected input button (S103).

On the other hand, the second detection unit 14 detects an input operation in a first direction to the detection section 153 by the user (S104A). The second detection unit 14 also detects an input operation in a second direction that is different from the first direction (S104B).

Then, if the input operation in the first direction has been detected by the second detection unit 14 (S104A: YES), the display unit 11 performs first switching by switching the display of the input buttons 1511 in the button display section 151 (S105A). If the input operation in the second direction has been detected by the second detection unit 14 (S104B: YES), the display unit 11 performs second switching by switching the display of the input buttons 1511 in the button display section 151 (S105B).

In the following, an example where input operations in the first and second directions are performed by way of flicking and the user inputs “#PAT” using the array groups shown in the table of FIG. 18B (the array groups correspond to those exemplified in (A) and (B) in FIG. 11 and FIG. 13B) will be described specifically. First, when the user performs upward flicking once in the state where the “left segment (0, 0)” of the key array of the keyboard employing the QWERTY layout is displayed (S101) in the button display section 151, input buttons indicating the “left segment (1, 0)” of the symbol key array of the keyboard are displayed (i.e., a set of steps (S104B) and (S105B) is performed once). Then, when the user taps “#” (S102), a character “#” is displayed in the input data display section 152 (S103). Next, when the user performs downward flicking once, input buttons indicating the “left segment (0, 0)” are displayed, and when the user performs leftward flicking once, input buttons indicating the “right segment (0, 1)” of the key array of the keyboard employing the QWERTY layout are displayed (i.e., a set of steps (S104B) and (S105B) is performed once, and a set of steps (S104A) and (S105A) is performed once). Then, when the user taps “P” (S102), a character “P” is displayed in the input data display section 152 (S103). Thereafter, when the user performs rightward flicking once, the input buttons indicating the “left segment (0, 0)” are displayed (i.e., a set of steps (S104A) and (S105A) is performed once). Then, when the user taps “A” (S102), a character “A” is displayed in the input data display section 152 (S103), and when the user taps “T” (S102), a character “T” is displayed in the input data display section 152 (S103).

### Second Embodiment

Next, a second embodiment will be described. As shown in FIGS. 21A and 21B, a data input device 20 of the present embodiment is a smartwatch that includes a touch panel type dial (touch panel 25). The data input device 20 has the same configuration as the data input device of the first embodiment, except that it includes, in addition to or instead of the touch panel 25, a detection section 263, which is an input device that enables touch input to the outside of the touch panel 25. In the data input device 20, the shape of the smartwatch, functions of the smartwatch other than the capability to perform character input, etc. are not particularly limited. The data input device 20 is not limited to a smartwatch, and may be, for example, a bracelet or the like.

Also in the present embodiment, a portion of the touch panel 25 serves as a button display section 251, and according to an input button selected by the user, the selected character is displayed in an input data display section 252 of the touch panel 25.

The data input device 20 of the present embodiment has the detection section 263 outside the dial (touch panel 25). The detection section 263 is not particularly limited as long as it is an input device that enables touch input, and any known input device can be used as the detection section 263. In the detection section 263, the display function is not essential.

FIGS. 21A and 21B show an example where a portion of a peripheral portion of the dial (touch panel 25) serves as the detection section 263. The peripheral portion is located at a position where, for example, the user can touch the detection section 263 at the same time with or immediately after touching the button display section 251 of the touch panel 25. The peripheral portion may be, for example, a bezel portion (e.g., a portion including side surfaces of the dial (touch panel 25)) as shown in FIGS. 21A and 21B, or may be a belt portion or the like. The belt portion may be a region located on the side opposite to the side on which the dial is provided (when the dial is on the back-of-hand side, the belt portion is on the palm side).

The user can perform input operations in a first direction and a second direction through flicking or swiping to the detection section 263 as in the first embodiment, for example. In the input operations in the first and second directions, for example, a crosswise direction and a vertical direction orthogonal to the crosswise direction may be set to the first direction and the second direction, as described above. Alternatively, as shown in FIGS. 21A and 21B, a peripheral direction of the touch panel 25, which is the dial, and a direction orthogonal to the peripheral direction (in FIGS. 21A and 21B, the depth direction indicated with the arrows) may be set to the first direction and the second direction. The peripheral direction of the touch panel 25 is, for example, the circumferential direction of the touch panel 25 when the touch panel 25 is circular.

The detection section 263 is disposed above the touch panel 25 as shown in FIG. 21A, for example. In this case, the user can perform an input operation to the detection section 263 using the forefinger or middle finger of his/her dominant hand, and can make a selection from the input buttons being displayed in the button display section 251 using the thumb of the dominant hand. On the other hand, when the detection section 263 is disposed below the touch panel 25, the user can perform an input operation to the detection section 263 using the thumb of the dominant hand, and can make a selection from the input buttons being displayed in the button display section 251 using the forefinger or middle finger of the dominant hand, for example.

The detection section 263 may include, for example, a detection section 263A and a detection section 263B. In each of the detection sections 263A and 263B, either one or both of input operations in the first direction and the second direction may be enabled. As shown in FIG. 21B, for example, the detection section 263A is disposed on a side surface of the touch panel 25 on the upper side in the drawing, and the detection section 263B is disposed on a side surface of the touch panel 25 on a lower side in the drawing. In this case, the user can perform input operations to the detection sections 263A and 263B using the middle finger or thumb of his/her dominant hand, and can make a selection from the input buttons displayed in the button display section 251 using the forefinger of the dominant hand. However, the present invention is not limited thereto, and the detection section 263 may be disposed on, for example, a side surface of the touch panel 25 on the left side or the right side in the drawing.

Alternatively, for example, the detection section 263 may be disposed so as to extend over the entire peripheral portion of the touch panel 25, which is the dial.

According to the present embodiment, character input is possible even when a touch panel portion is small as in the case of a smartwatch or when the user can use only one hand for character input operations, for example.

### Third Embodiment

Next, a third embodiment will be described. A data input device 30 of the present embodiment, which is a game machine, has the same configuration as the data input device of the first embodiment, except that a display unit 31 displays input buttons in a button display section 351 of a monitor 35, an input unit 33 displays a selected character in an input data display section 352 of the monitor 35, and a stick of a controller 36 serves as a detection section 363. The game machine is not particularly limited. Also, the data input device 30 is not limited to a game machine.

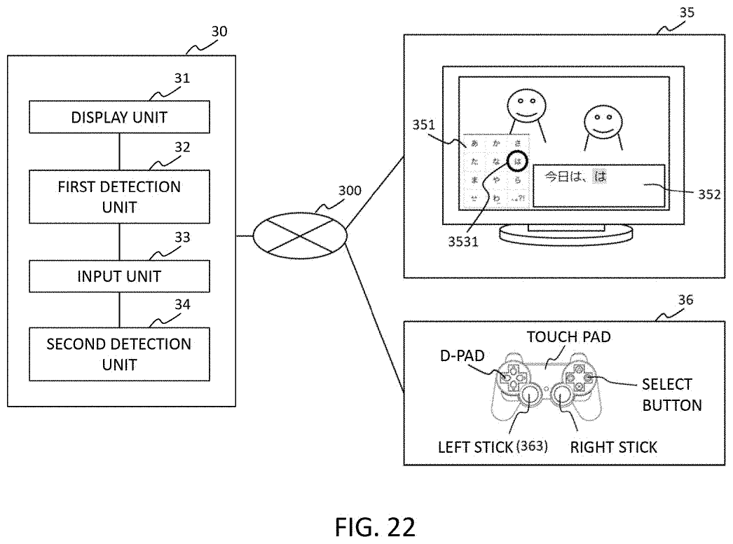

FIG. 22 is a block diagram showing an example of the configuration of the data input device 30 of the present embodiment. The data input device 30 includes the display unit 31, a first detection unit 32, the input unit 33, and a second detection unit 34. The data input device 30 is connected to the monitor 35 and the controller 36 via a wired or wireless communication line network 300.

The user can perform input operations in the first and second directions by, for example, tilting a left stick, which is the detection section 363, of the controller 36. Next, the user can select a desired character by, for example, pressing a select button after moving a cursor 3531 on the desired character by, e.g., tilting a right stick of the controller 36. By setting the operations as described above, for example, an operation for displaying a character can be assigned to the user's left hand and an operation for selecting a character can be assigned to the user's right hand. The combination to which the input operations in the first and second directions and the character selection are assigned is not limited to the above-described combination, and the left stick, the right stick, a touch pad, a D-pad, and the like may be selected as appropriate to make any desired combination. Further, a mouse, a keyboard, and the like connected to the data input device 30 also may be used in combination.

The present embodiment also can be referred to as, for example, a data input system that includes a screen (the monitor 35), a reception device (the controller 36), and the data input device 30. As described above, the screen includes the button display section 351, and the reception device includes the detection section 363. The screen is not particularly limited as long as it can display the input buttons.

### Fourth Embodiment

Next, a fourth embodiment will be described. A data input device of the present embodiment, which is a personal computer (PC), has the same configuration as the data input device of the third embodiment except that, instead of the controller 36, a mouse connected to the PC via wired or wireless means serves as a detection section. The PC is not particularly limited. Also, the data input device is not limited to a PC.

The user can perform an input operation in a first direction and an input operation in a second direction by, for example, moving the mouse, which is the detection section, in a crosswise direction and a vertical direction. That is, the user can perform the input operations in the first and second directions by, for example, moving a character selection cursor displayed on a monitor through an operation of the mouse. Thereafter, the user can select a desired character by, for example, clicking the mouse after moving the cursor on the desired character.

In the present embodiment, the movement of the mouse may correspond only to the input operations in the first and second directions, may correspond to the input operations in the first and second directions and to the character selection in different manners, or may correspond to both of them in the same manner. When the movement of the mouse corresponds to the input operations and to the character selection in different manners, for example, the mouse may be moved while clicking the mouse (or performing a predetermined key input operation) to perform an input operation for either one of them, and may be moved without clicking the mouse (or without performing the predetermined key input operation) to perform an input operation for the other one of them.

When the movement of the mouse corresponds to the input operations in the first and second directions and to the character selection in the same manner, determination may be made as to whether the mouse has been moved for input operations in the first and second directions (i.e., not for the character selection or meaningless movement of the cursor). The above-described determination is not particularly limited. For example, the determination may be made as to whether the mouse (or the cursor) has been moved by a predetermined distance or longer in the respective directions within a predetermined period of time. Alternatively, for example, end regions may be provided on upper, lower, left, and right sides of the detection section 153 (or the button display section 151, the touch panel 15, or the like), and whether the mouse (or the cursor) has been present in the upper and lower (or right and left) end regions within a predetermined period of time may be determined. The above-described determination as to whether the mouse has been moved for the input operations may be made based on the order in which the mouse (or the cursor) has been present in these regions. In this case, for example, the input operations in the first and second directions may be achieved through a reciprocating movement. That is, when the cursor has been present in the end regions in the order of the “left, right, and left” or “right, left, and right” end regions, it is determined that an input operation in the first direction has been made, and when the cursor has been present in the end regions in the order of the “upper, lower, and upper” or “lower, upper, and lower” end regions, it is determined that an input operation in the second direction has been made. In this case, the “direction of movement” such as “from left to right” in the first direction and the second direction may or may not be determined. The reciprocating movement is not particularly limited as long as the mouse is reciprocated at least once. The movement may be, for example, a linear movement or a curve movement.

On the contrary, determination may be made as to whether the mouse has been moved for an input operation for the character selection (i.e., not for the input operations in the first and second directions or meaningless movement of the cursor). The above-described determination is not particularly limited, and may be made based on, for example, whether the cursor has been placed on a desired character for a predetermined period of time or longer or whether the cursor has been moved around the desired character.

As described above, according the present embodiment, for example, the input operations in the first and second directions also can be performed through operations using an input device, such as a mouse, in which there is no distinction between an input state and a non-input state.

### Fifth Embodiment

Next, a fifth embodiment will be described. A data input device of the present embodiment has the same configuration as the detection device of the fourth embodiment, except that it further includes a projection device for projecting input buttons on a screen, a laser pointer, and a detection device for detecting a laser spot projected on the screen by the laser pointer, the screen serves as a button display section, and the detection device serves as a detection section. The screen, the projection device, and the detection device are not particularly limited.

The user can perform input operations in first and second directions by, for example, reciprocating a laser spot in a crosswise direction and a vertical direction. Thereafter, the user can select a desired character by, for example, performing a predetermined operation after moving the laser spot on the desired character among characters on the projected input buttons. The predetermined operation may be, for example, the same as that in the case where the mouse is used or may be blinking or the like of the laser spot.

### Sixth Embodiment

Next, a sixth embodiment will be described. A data input device of the present embodiment, which is a mobile device, has the same configuration as the data input device of the first embodiment, except that a display unit displays input buttons in a button display section of a monitor that is provided separately from the mobile device, an input unit displays a selected character in an input data display section of the monitor, and a touch panel of the data input device serves as a detection section.

According the present embodiment, through operations of the data input device, which is the mobile device, it is possible to switch the display of the input buttons on the monitor and to make a selection from the input buttons, for example.

The present embodiment also can be referred to as, for example, a data input system that includes a screen (the monitor) and the data input device (the mobile device). As described above, the screen includes the button display section, and the data input device includes the detection section.

### Seventh Embodiment

Next, a seventh embodiment will be described. In the present embodiment, the data input device is goggles for virtual reality (VR) equipment or the like. The data input device may be, for example, the goggles in which a mobile device such as a smartphone is set. By wearing the goggles, the user can view an image displayed on a display of the goggles. The user holds in one or both hands a remote controller for performing operations corresponding to the image.

In the data input device, a display unit displays input buttons on a button display section in the display, and an input unit displays a character selected from the input buttons on an input data display section of the display. On the other hand, a touch pad, a stick, or the like of the remote controller serves as a detection section. Except for the above, the data input device of the present embodiment has the same configuration as the data input device of the first embodiment.

The present embodiment also can be referred to as, for example, a data input system that includes a reception device (the remote controller) and the data input device (the mobile device). As described above, the reception device includes the detection section, and the data input device includes the button display section.

### Eighth Embodiment

A program according to the present embodiment is a program for causing a computer to execute the respective steps in the above-described data input method. In the present invention, the terms “procedure” and “processing” are used interchangeably with each other. The program of the present embodiment may be recorded in a computer-readable recording medium, for example. The recording medium is not particularly limited, and may be, for example, a random-access memory (RAM), a read-only memory (ROM), a hard disk (HD), or an optical disk.

While the present invention has been described above with reference to example embodiments, the present invention is by no means limited thereto. Various changes and modifications that may become apparent to those skilled in the art may be made in the configuration and specifics of the present invention without departing from the scope of the present invention.

### INDUSTRIAL APPLICABILITY

The present invention can provide a novel character input system.

### REFERENCE SIGNS LIST

10 data input device
11 display unit
12 first detection unit
13 input unit
14 second detection unit
15 touch panel
151, 251, 351 button display section
152, 252, 352 input data display section
153, 263, 363 detection section
35 monitor
36 controller
1001A, 1001B, 1001C finger

1. A data input device comprising:
a display unit;
a first detection unit;
an input unit; and
a second detection unit,
the display unit being configured to display input buttons in a plurality of rows and columns in a button display section,
the first detection unit being configured to detect a selection from the input buttons by a user,
the input unit being configured to perform data input according to the selected input button,
the second detection unit being configured to detect an input operation in a first direction and an input operation in a second direction that is different from the first direction to a detection section by the user, wherein
the display unit displays, as the input buttons, partial arrays included in an array group in at least one category selected from the following categories (i-2), (i-3), and (iv):
(i-2) an array group that includes partial arrays obtained by dividing a character input array for input of an alphabet through a multi-tap operation based on an order of display in response to input operations to respective ten number keys;
(i-3) an array group that includes partial arrays obtained by dividing a character input array for input of symbols through a multi-tap operation based on an order of display in response to an input operation to the respective ten number keys;
(iv) an array group that includes partial arrays obtained by dividing arrangement of alphabet letters in alphabetical order into two to four segments,
the display unit performs first switching by switching a display of the input buttons in the button display section in response to the input operation in the first direction, and performs second switching by switching a display of the input buttons in the button display section in response to the input operation in the second direction,
the first switching is switching to a different one of the partial arrays in the same array group, and
the second switching is switching to one of the array groups in the other categories or to a different one of the array groups in the same category.

2. The data input device according to claim 1, wherein
the partial arrays included in the array group include a character common to these partial arrays.

3. The data input device according to claim 1, wherein
the display unit provides a display resulting from the first switching and a display resulting from the second switching according to their display order, and changes a display mode of the input buttons according to the display order of the displayed partial array.

4. The data input device according to claim 1, wherein
the second detection unit detects an amount of movement of each of the input operation in the first direction and the input operation of the second direction to the detection section,
the first switching to be performed once corresponds to a predetermined amount of movement of the input operation in the first direction and the second switching to be performed once corresponds to a predetermined amount of movement of the input operation in the second direction, and
the display unit switches the input buttons based on the amounts of movement detected by the second detection unit.

5. The data input device according to claim 4, wherein
the display unit provides a display resulting from the first switching and a display resulting from the second switching according to their display order, and
in the first direction or the second direction and the first switching or the second switching corresponding thereto, the following formula is satisfied:
P≤X/(n−1) Formula:
P: the predetermined amount of movement corresponding to the switching to be performed once,
X: at least one selected from the group consisting of a movable range of a finger or a stylus, a size of the detection section, and a movable range of the detection section,
n: the number of first to last partial arrays in the display order.

6. The data input device according to claim 1, wherein
the partial arrays are associated with row information that indicates the display order resulting from the first switching and column information that indicates the display order resulting from the second switching,
in the first switching, the display unit changes the column information associated with a partial array being displayed without changing the row information and then displays, as a partial array after the first switching, a partial array associated with the row information and column information after being thus changed, and
in the second switching, when the second switching is switching to a different one of the array groups in the same category, the display unit changes the row information associated with a partial array being displayed without changing the column information, and when the second switching is switching to one of the array groups in the other categories, the display unit changes the column information of a partial array being displayed to column information at an initial position and also changes the row information, and then displays, as a partial array after the second switching, a partial array associated with the row information and column information after being thus changed.

7. The data input device according to claim 1, wherein
the input operations to the detection section are touch input operations, and the input operation in the first direction and the input operation in the second direction are each performed by flicking or swiping.

8. The data input device according to claim 1, wherein
the button display section and the detection section are provided using a common region in a touch panel.

9. The data input device according to claim 1, which is a mobile device that includes the button display section and the detection section.

10. The data input device according to claim 9, which is a smartwatch that includes a touch panel type dial, wherein
at least a portion of the dial serves as the button display section, and
at least a portion of a peripheral portion of the dial serves as the detection section.

11. The data input device according to claim 1, wherein
the second detection unit corrects an input operation in a direction that is not parallel to the first direction or the second direction in such a manner that the direction corresponds to either the first direction or the second direction, or processes the input operation as an input operation that combines the input operation in the first direction and the input operation in the second direction.

12. A data input method comprising:
a display step;
a first detection step;
an input step; and
a second detection step, wherein
the display step is a step of displaying input buttons in a plurality of rows and columns in a button display section,
the first detection step is a step of detecting a selection from the input buttons by a user,
the input step is a step of performing data input according to the selected input button,
the second detection step is a step of detecting an input operation in a first direction and an input operation in a second direction that is different from the first direction to a detection section by the user,
in the display step, as the input buttons, partial arrays included in an array group in at least one category selected from the following categories (i-2), (i-3), and (iv) are displayed:
(i-2) an array group that includes partial arrays obtained by dividing a character input array for input of an alphabet through a multi-tap operation based on an order of display in response to input operations to respective ten number keys;
(i-3) an array group that includes partial arrays obtained by dividing a character input array for input of symbols through a multi-tap operation based on an order of display in response to an input operation to the respective ten number keys;
(iv) an array group that includes partial arrays obtained by dividing arrangement of alphabet letters in alphabetical order into two to four segments,
the display unit performs first switching by switching a display of the input buttons in the button display section in response to the input operation in the first direction, and performs second switching by switching a display of the input buttons in the button display section in response to the input operation in the second direction,
the first switching is switching to a different one of the partial arrays in the same array group,
the second switching is switching to one of the array groups in the other categories or to a different one of the array groups in the same category, and
the respective steps are executed by a computer.

13. A non-transitory computer-readable recording medium having recorded thereon a program for causing a computer to execute the respective steps in the data input method according to claim 12.
